(19) United States
(12) Patent Application Publication
(10) Pub. No.: US 2024/0196310 A1
(43) Pub. Date: Jun. 13, 2024

(54) PROVIDING NEIGHBOUR CELL INFORMATION IN NON-TERRESTRIAL NETWORK

(71) Applicant: Samsung Electronics Co., Ltd., Suwon-si (KR)

(72) Inventors: Jonas SEDIN, Staines (GB); Chadi KHIRALLAH, Staines (GB)

(21) Appl. No.: 18/473,624

(22) Filed: Sep. 25, 2023

(30) Foreign Application Priority Data
Dec. 12, 2022 (GB) 2218669.6
Jul. 25, 2023 (GB) 2311362.4

(51) Int. Cl. H04W 48/08

(52) U.S. Cl. CPC H04W 48/08; H04W 84/06

(57) ABSTRACT

The disclosure relates to a 5^{th} generation (5G) or 6^{th} generation (6G) communication system for supporting a higher data transmission rate. A method performed by a user equipment (UE) in a wireless communication system is provided. The method includes receiving, from a base station, a first system information block (SIB) associated with satellite assistance information, the first SIB including first information on serving cell ephemeris and second information on a validity duration of the serving cell ephemeris, and receiving, from the base station, a second system information block (SIB) associated with neighbor satellite information based on a first timer with a duration of the validity duration of the serving cell ephemeris and a second timer for an acquisition of the first SIB before a radio link failure (RLF), the second SIB including third information on neighbor cell ephemeris.

### CROSS-REFERENCE TO RELATED APPLICATION(S)

This application is based on and claims priority under 35 U.S.C. § 119(a) of a United Kingdom patent application number 2218669.6, filed on Dec. 12, 2022, in the United Kingdom Intellectual Property Office, and of a United Kingdom patent application number 2311362.4, filed on Jul. 25, 2023, in the United Kingdom Intellectual Property Office, the disclosure of each of which is incorporated by reference herein in its entirety.

### BACKGROUND

### 1. Field

The disclosure relates to non-terrestrial network (NTN). More particularly, the disclosure relates to methods and apparatuses for providing neighbour cell Information in non-terrestrial network.

Certain examples of the disclosure provide one or more techniques for providing neighbour cell information in a non terrestrial network (NTN). For example, certain examples of the disclosure provide one or more techniques for providing neighbour cell information in a 3^{rd} generation partnership project (3GPP) 5^{th} generation (5G) new radio (NR) NTN.

### 2. Description of Related Art

5G mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter-wave (mmWave) including 28 GHz and 39 GHz. In addition, it has been considered to implement 6^{th} Generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random-access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and apparatuses for providing neighbor cell Information in non-terrestrial network.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a base station, a first system information block (SIB) associated with satellite assistance information, the first SIB including first information on serving cell ephemeris and second information on a validity duration of the serving cell ephemeris, and receiving, from the base station, a second system information block (SIB) associated with neighbor satellite information based on a first timer with a duration of the validity duration of the serving cell ephemeris and a second timer for an acquisition of the first SIB before a radio link failure (RLF), the second SIB including third information on neighbor cell ephemeris.

In accordance with another aspect of the disclosure, a UE in a wireless communication system is provided. The UE includes a transceiver, and a controller coupled with the transceiver and configured to receive, from a base station, a first SIB associated with satellite assistance information, the first SIB including first information on serving cell ephemeris and second information on a validity duration of the serving cell ephemeris, and receive, from the base station, a second SIB associated with neighbor satellite information based on a first timer with a duration of the validity duration of the serving cell ephemeris and a second timer for an acquisition of the first SIB before an RLF, the second SIB including third information on neighbor cell ephemeris.

In accordance with another aspect of the disclosure, a method performed by a base station in a wireless communication system is provided. The method includes transmitting, to a UE, a first SIB associated with satellite assistance information, the first SIB including first information on serving cell ephemeris and second information on a validity duration of the serving cell ephemeris, and transmitting, to the UE, a SIB associated with neighbor satellite information based on a first timer with a duration of the validity duration of the serving cell ephemeris and a second timer for an acquisition of the first SIB before an RLF, the second SIB including third information on neighbor cell ephemeris.

In accordance with another aspect of the disclosure, a base station in a wireless communication system is provided. The base station includes a transceiver, and a controller coupled with the transceiver and configured to transmit, to a UE, a first SIB associated with satellite assistance information, the first SIB including first information on serving cell ephemeris and second information on a validity duration of the serving cell ephemeris, and transmit, to the UE, a second SIB associated with neighbor satellite information based on a first timer with a duration of the validity duration of the serving cell ephemeris and a second timer for an acquisition of the first SIB before an RLF, the second SIB including third information on neighbor cell ephemeris.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B illustrate an ephemeris synchronization operation in FIG. 1A a system information block (SIB)31 functions as normal, and in FIG. 1B a user equipment (UE) fails to read SIB31 during T318 which then expires and triggers a radio link failure (RLF) according to various embodiments of the disclosure;

FIG. 2 illustrates a neighbour cell request and response through dedicated signalling initiated by UE according to an embodiment of the disclosure;

FIG. 3 illustrates a neighbour cell ephemeris request provided in a UE assistance information message according to an embodiment of the disclosure;

FIG. 4 illustrates moving to a radio resource control (RRC) connected mode from RRC idle mode to acquire neighbour cell ephemeris information according to an embodiment of the disclosure;

FIG. 5 illustrates reading SIB containing neighbour cell ephemeris after reading SIB31 after uplink synchronization has expired (T317) with an extended guard timer (T318) according to an embodiment of the disclosure;

FIG. 6 illustrates providing non-terrestrial networks (NTN) neighbour cell ephemeris over a terrestrial network (TN) cell according to an embodiment of the disclosure;

FIG. 7A illustrates acquiring broadcast NTN neighbour cell ephemeris according to an embodiment of the disclosure, and FIG. 7B illustrates an example of indicating that NTN cell ephemeris is needed through dedicated signalling according to an embodiment of the disclosure;

FIG. 8 is a block diagram of a network entity that may be used in certain examples of the disclosure according to an embodiment of the disclosure;

FIG. 9 illustrates a structure of a UE according to an embodiment of the disclosure; and

FIG. 10 illustrates a structure of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

One of the areas currently under development in 3^{rd} generation partnership project (3GPP) 5^{th} generation (5G) wireless technology is support for non-terrestrial networks (NTNs). An NTN is a network in which one or more nodes (e.g., a next generation radio access network (NG-RAN) node) are provided by a non-terrestrial infrastructure, for example a satellite or high altitude platform station (HAPS). Advantages of using an NTN include (i) extending coverage to regions, such as remote areas, with limited or no coverage from more traditional terrestrial networks, (ii) providing continuous coverage in the event of inoperability of traditional terrestrial networks, such as during natural disasters, and (iii) enhancing overall reliability, resilience and capacity when used in conjunction with existing terrestrial networks.

A satellite network implementing a network node provides coverage through one or more radio beams forming a “footprint” on the surface of the earth defining a coverage area or cell. An NTN cell may be Earth-moving (i.e., moving over the earth's surface according to the motion of the satellite, for example in the case of a lower earth orbit (LEO) satellite), Earth-fixed (i.e., a fixed area of the Earth's surface, for example in the case of a geosynchronous equatorial orbit (GEO) satellite) or quasi-Earth-fixed (i.e., a fixed area of the Earth's surface but is maintained for only a limited time as the satellite passes by).

Internet of things (IOT) NTN was a 3GPP study and work item in 3GPP release 17 (RP-202689, RAN #90 December 2020) to provide NTN access for evolved universal terrestrial radio access network (E-UTRAN) IoT devices (e.g., narrowband (NB)-IOT and long term evolution machine type communication (LTE-M), including enhanced machine type communication (eMTC)). As noted in 3GPP RP-202689, IoT operation is critical in remote areas with low/no cellular connectivity for many different industries. The capabilities of NB-IOT and eMTC are a good fit for many applications but some applications may require satellite connectivity to provide coverage beyond terrestrial deployments.

NR NTN was a work item in Release 17 to specify adaptation to allow NR to function over NTN (RP-211557, RAN #91-e March 2021).

Following the work items in Release 17 there were work items to enhance NR NTN (RP-220953, RAN #95-e March 2022) and IoT NTN (RP-220979, RAN #95-e March 2022) in Release 18.

Due to the movement of satellites in a non-stationary orbit (e.g., LEO), the cells that a UE see will be moving (i.e., Earth-moving cells). This results in frequent UE handover from one cell to another, and this handover of service will happen constantly. In view of this, mobility is one of the key issues in both NR NTN and IoT NTN.

### Abbreviations/Definitions

In the disclosure, the following acronyms/definitions are used.
3GPP 3^{rd} generation partnership project
5G 5^{th} generation
AMF access and mobility management Function
AS access stratum
CFRA contention free random access
eMTC enhanced machine type communication
eNB base station
EPC evolved packet core
E-UTRAN evolved universal terrestrial radio access network
GEO geosynchronous equatorial orbit
gNB 5G base station
HAPS high altitude platform station
ID identity/identification
IE information element
IMEISV international mobile station equipment identity and software version
IOT Internet of things
LEO lower earth orbit
LTE long term evolution
LTE-M LTE machine type communication
MAC medium access control
MDT minimisation of drive test
MME mobility management entity
NB narrow band
NG next generation
NR new radio
NTN non-terrestrial network
PCI physical cell ID
PLMN public land mobile network
ProSe proximity-based services
RAN radio access network
RAT radio access technology
RLF radio link failure
c-RNTI cell radio network temporary identifier
RRC radio resource control
RRM radio resource management
S-GW serving gateway
SMF session management function
SRVCC single radio voice call continuity
TS technical specification
UE user equipment
UPF user plane function
V2X vehicle to everything
X2/Xn interface between RAN nodes

### Overview of NTN System Information

As NTN has a number of NTN-specific information elements that are only required when accessing an NTN cell, and also due to the relatively large information elements, it was agreed that new system information blocks (SIBs) are needed.

In NR NTN, SIB19 contains the required information to access an NTN cell like below Table 1:

TABLE 1

| | |
|---|---|
| | ------------------------------ 3GPP TS 38.331 V17.2.0 ------------------------------ |
| - | SIB19 |

SIB19 contains satellite assistance information for NTN access.
SIB19 information element
-- ASN1START
-- TAG-SIB19-START
SIB19-r17 ::= SEQUENCE {

| | | |
|---|---|---|
| ntn-Config-r17 | NTN-Config-r17 | OPTIONAL, - |

- Need R

| | | |
|---|---|---|
| t-Service-r17 | INTEGER (0..549755813887) | OPTIONAL, |

-- Need R

| | | |
|---|---|---|
| referenceLocation-r17 | ReferenceLocation-r17 | OPTIONAL, |

-- Need R

| | | |
|---|---|---|
| distanceThresh-r17 | INTEGER(0..65525) | OPTIONAL, |

-- Need R

| | |
|---|---|
| ntn-NeighCellConfigList-r17 | NTN-NeighCellConfigList-r17 |

OPTIONAL, -- Need R

| | |
|---|---|
| lateNonCriticalExtension | OCTET STRING |

```
OPTIONAL,
  ...,
  [[
```

| | |
|---|---|
| ntn-NeighCellConfigListExt-v1720 | NTN-NeighCellConfigList-r17 |

OPTIONAL -- Need R
]]
}

| | |
|---|---|
| NTN-NeighCellConfigList-r17 ::= | SEQUENCE (SIZE(1..maxCellNTN-r17)) OF |

NTN-NeighCellConfig-r17

| NTN-NeighCellConfig-r17 ::= | SEQUENCE { | |
|---|---|---|
| ntn-Config-r17 | NTN-Config-r17 | OPTIONAL, - |

- Need R

| | | |
|---|---|---|
| carrierFreq-r17 | ARFCN-ValueNR | OPTIONAL, |

-- Need R

| | | |
|---|---|---|
| physCellId-r17 | PhysCellId | OPTIONAL -- |

Need R
}
-- TAG-SIB19-STOP
-- ASN1STOP
SIB19 field descriptions
distance Thresh
Distance from the serving cell reference location and is used in location-based
measurement initiation in RRC_IDLE and RRC_INACTIVE, as defined in TS
38.304 [20]. Each step represents 50 m.
ntn-Config
Provides parameters needed for the UE to access NR via NTN access, such as
Ephemeris data, common TA parameters, k_offset, validity duration for UL sync
information and epoch.
ntn-NeighCellConfigList, ntn-NeighCellConfigListExt
Provides a list of NTN neighbour cells including their ntn-Config, carrier
frequency and PhysCellId. This set includes all elements of ntn-
NeighCellConfigList and all elements of ntn-NeighCellConfigListExt. If ntn-
Config is absent for an entry in ntn-NeighCellConfigListExt, the ntn-Config
provided in the entry at the same position in ntn-NeighCellConfigList applies.
referenceLocation
Reference location of the serving cell provided via NTN quasi-Earth fixed system
and is used in location-based measurement initiation in RRC_IDLE and
RRC_INACTIVE, as defined in TS 38.304 [20].
t-Service
Indicates the time information on when a cell provided via NTN quasi-Earth fixed
system is going to stop serving the area it is currently covering. The field indicates
a time in multiples of 10 ms after 00:00:00 on Gregorian calendar date 1 January,
1900 (midnight between Sunday, December 31, 1899 and Monday, January 1,
1900). The exact stop time is between the time indicated by the value of this field
minus 1 and the time indicated by the value of this field.

------------------------------ 3GPP TS 38.331 V17.2.0 ------------------------------

In IoT NTN, SIB31 contains the required information to access an IoT NTN cell like below Table 2:

TABLE 2

| | |
|---|---|
| | ------------------------------ 3GPP TS 36.331 V17.2.0 ------------------------------ |
| - | SystemInformationBlockType31 |

The IE SystemInformationBlockType31 contains satellite assistance information for the
serving cell. SystemInformationBlockType31 is only signalled in an NTN cell.
SystemInformationBlockType31 information element
-- ASN1START
SystemInformationBlockType31-r17 ::= SEQUENCE {

| servingSatelliteInfo-r17 | ServingSatelliteInfo-r17, | |
|---|---|---|
| lateNonCriticalExtension | OCTET STRING | OPTIONAL, |

...
}

| ServingSatelliteInfo-r17 ::= | | SEQUENCE { |
|---|---|---|
| ephemerisInfo-r17 | | CHOICE { |
| | state Vectors | EphemerisStateVectors-r17, |
| | orbitalParameters | EphemerisOrbitalParameters-r17 |

},

| nta-CommonParameters-17 | | SEQUENCE { | |
|---|---|---|---|
| | nta-Common-r17 | INTEGER (0..8316827) | OPTIONAL, |

-- Need OP

| | | |
|---|---|---|
| nta-CommonDrift-r17 | INTEGER (−261935..261935) | OPTIONAL, |

-- Need OP

| | | |
|---|---|---|
| nta-CommonDriftVariation-r17 | INTEGER (0..29479) | OPTIONAL -- |

Need OP
},

| | |
|---|---|
| ul-SyncValidityDuration-r17 | ENUMERATED {s5, s10, s15, s20, s25, s30, s35, |

s40,

s45, s50, s55, s60, s120, s180, s240, s900},

| | |
|---|---|
| epochTime-r17 | SEQUENCE { |

| | |
|---|---|
| startSFN-r17 | INTEGER (0..1023), |
| startSubFrame-r17 | INTEGER (0..9) |

| | |
|---|---|
| } | OPTIONAL, -- Need |

OP

| k-Offset-r17 | INTEGER (0..1023), | |
|---|---|---|
| k-Mac-r17 | INTEGER (1..512) | OPTIONAL, -- Need |

OP
...
}
-- ASN1STOP
SystemInformationBlockType31 field descriptions
epoch Time
Epoch time of the satellite ephemeris data and common TA parameters, see TS
36.213 [23]. The reference point for epoch time of the serving satellite ephemeris
and Common TA parameters is the uplink time synchronization reference point.
epochTime is the starting time of a DL subframe indicated by startSFN and
startSubframe.
If the field is absent, the UE uses the starting time of the DL subframe
corresponding to the end of the SI window during which the SI message carrying
SIB31 is transmitted.
E-UTRAN always includes epochTime when SystemInformationBlockType31 is
provided through dedicated signalling.
k-Mac
Scheduling offset used when downlink and uplink frame timing are not aligned at
the eNB, see TS 36.213 [23]. Unit in ms.
If the field if absent, the UE uses the (default) value of 0.
k-Offset
Scheduling offset used in the timing relationships in NTN, see TS 36.213 [23].
Unit in ms.
nta-Common
Network-controlled common TA, see TS 36.213 [23]. Unit of μs.
Step of 32.55208 × 10⁻³ μs. Actual value = field value * 32.55208 × 10⁻³.
If the field is absent, the UE uses the (default) value of 0.
nta-CommonDrift
Drift rate of the common TA, see TS 36.213 [23]. Unit of μs/s.
Step of 0.2 × 10⁻³ μs/s. Actual value = field value * 0.2 × 10⁻³.
If the field is absent, the UE uses the (default) value of 0.
nta-CommonDriftVariation
Drift rate variation of the common TA, see TS 36.213 [23]. Unit of μs/s².
Step of 0.2 × 10⁻⁴ μs/s². Actual value = field value * 0.2 × 10⁻⁴.
If the field is absent, the UE uses the (default) value of 0.
orbitalParameters
Instantaneous values of the satellite orbital parameters. The signalled values are
only valid for the duration as defined by ul-SyncValidationDuration and
epochTime.
state Vectors
Instantaneous values of the satellite state vectors. The signalled values are only
valid for the duration as defined by ul-SyncValidationDuration and epochTime.
ul-Sync ValidationDuration
Validity duration of the satellite ephemeris data and common TA parameters, i.e.,
maximum time during which the UE can apply the satellite ephemeris without
acquiring new satellite ephemeris, see TS 36.213 [23]. Unit in second.
Value s5 corresponds to 5 seconds, value s10 corresponds to 10 seconds and so
on.

The system information contains the following:
Serving cell ephemeris elements. This allows the UE to calculate the satellite position for doppler and time pre-compensation. This information may be provided in two formats:
PVT format. This describes a (X, Y, Z) position as well as a speed vector (vX, vY, vZ).
Orbital parameters. This describes the orbital movements of the satellite which is then used to infer the satellite position.
TA common parameters. This provides the common timing advance parameters which is introduced to compensate for the feeder link delays. The signalling comprises the following (in total taking up 57 bits):
Absolute TA common (23 bits).
Drift of the TA common, defining how the TA common drifts, i.e., the first derivative of the TA common (19 bits).
Variation of the TA common, defining how the TA common varies, i.e., the second derivative of the TA common (15 bits).
Synchronization validity duration. This is used to define how long the ephemeris and TA common is valid.
Epoch time. This defines when the synchronization validity duration should start.
K-Offset. This is a scheduling offset for timing relationship in NTN.
K-Mac. This is a scheduling offset used when the downlink and uplink frame timing is not aligned.
NR NTN specific information also includes (as part of 3GPP TS 38.331):
T-Service (signalled in SIB3 in IoT NTN).
Reference location and distance threshold. This is used for location-based measurement initiation in RRC IDLE and RRC Connected mode.
Neighbour cell ephemeris. This is used for idle mode measurements.

### Overview of NTN System Information Acquisition

As ephemeris information constantly changes due to the movement of the NTN payload (e.g., satellite), there is a need to make sure that the UE is correctly synchronized. Thus, whenever a UE connects to an eNB, the UE needs to read the system information (e.g., SIB19 or SIB31).

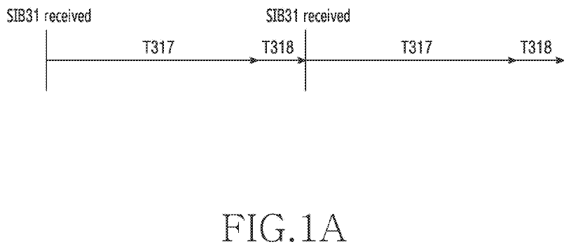

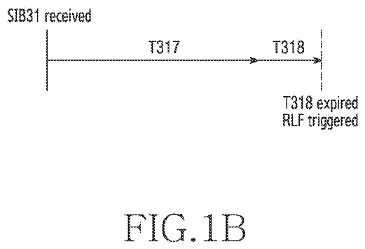

FIGS. 1A and 1B illustrate examples of an ephemeris synchronization operation in FIG. 1A SIB31 functions as normal, and in FIG. 1B UE fails to read SIB31 during T318 which then expires and triggers RLF according to various embodiments of the disclosure.

Referring to FIGS. 1A and 1B, in IoT NTN, every time SIB31 is read, a timer (T317) associated with the ephemeris element is started. At expiry of T317, the UE is no longer considered synchronized and should re-acquire SIB31 in order to stay synchronized.

In IoT NTN, since an IoT UE (LTE-M and NB-IOT UE) is not expected to be able to acquire system information in connected mode, the UE tunes away and is likely unreachable while reading SIB31.

If the IoT NTN UE is unable to read the SIB31 within a timer (T318) with a configured duration, the UE performs radio link failure (RLF) similar to other cases where RLF is performed. This operation can be seen in FIGS. 1A and 1B.

In NR NTN, the UE shall ensure that it has a recent ephemeris (SIB19 in NR) by reading the SIB in time by UE implementation.

### Overview of NTN Ephemeris Formats

There are three ways of signalling the ephemeris in NTN:
PVT format,
Orbital ephemeris elements, and
TLE ephemeris elements (only used for discontinuous coverage in IoT NTN).
PVT Format

PVT format signals XYZ position along with the speed vector vXYZ. This can be seen in the following information element like below Table 3:

TABLE 3

| | |
|---|---|
| | ------------------------------ 3GPP TS 36.331 V17.2.0 ------------------------------ |
| - | EphemerisStateVectors |

The IE EphemerisStateVectors provides satellite ephemeris in format of position and
velocity state vectors in ECEF.
EphemerisStateVectors information element
-- ASN1START
EphemerisStateVectors-r17 ::= SEQUENCE {

| | |
|---|---|
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}
PositionStateVector-r17 ::= INTEGER (−33554432..33554431)
VelocityStateVector-r17 ::= INTEGER (−131072..131071)
-- ASN1STOP
EphemerisStateVectors field descriptions
positionX, positionY, positionZ
X, Y, Z coordinate of satellite position state vector in ECEF. Unit in meter.
Step of 1.3 m. Actual value = field value * 1.3.
velocity VX, velocity VY, velocity VZ
X, Y, Z coordinate of satellite velocity state vector in ECEF. Unit in
meter/second.
Step of 0.06 m/s. Actual value = field value * 0.06.

------------------------------ 3GPP TS 36.331 V17.2.0 ------------------------------

The position elements (X, Y, Z respectively) each occupy 26 bits and the speed elements (vX, vY, vZ) each occupy 18 bits. Altogether they occupy 132 bits.

### Orbital Ephemeris Format

The ephemeris orbital parameters (also referred to as Keplerian format) provide parameters that indicate how a celestial body moves in space, which allows for accurate synchronization and prediction of future NTN payload position.

Ephemeris orbital elements are signalled by the following elements (164 bits total):
SemiMajorAxis (33 bits);
Eccentricity (20 bits);
Periapsis (28 bits);
Longitude (28 bits);
Inclination (27 bits); and
Anomaly (28 bits).

### TLE Orbital Parameters

The TLE parameters are based on two-line element set (TLE), which is industry-acknowledged data format for signalling the movement of a celestial body. Whereas the PVT and orbital ephemeris formats may be used to perform accurate synchronization, TLE parameters may be used primarily for long term prediction. For example, the TLE parameters allow for accurate satellite-pass prediction of up to several days in the future.

A full set of TLE parameters can occupy more than 50 Bytes of data containing many fields not required in 3GPP. Therefore, a reduced set of TLE parameters may be used instead, for example based on the following (totaling 189 bits): Inclination (21 bits);
Argument of perigee (22 bits);
Right ascension of the ascending node (22 bits);
Mean anomaly (22 bits);
Eccentricity (24 bits);
Mean motion (34 bits);
B* signalled by (i) a decimal (18 bits), and (ii) an exponent (5 bits); and
Epoch star (21 bits).

It is an aim of certain examples of the disclosure to address, solve and/or mitigate, at least partly, at least one of the problems and/or disadvantages associated with the related art, for example at least one of the problems and/or disadvantages described herein. It is an aim of certain examples of the disclosure to provide at least one advantage over the related art, for example at least one of the advantages described herein.

The disclosure is defined in the independent claims. Advantageous features are defined in the dependent claims. Embodiments or examples disclosed in the description and/or figures falling outside the scope of the claims are to be understood as examples useful for understanding the disclosure.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, language in the general form of “X for Y” (where Y is some action, process, operation, function, activity or step and X is some means for carrying out that action, process, operation, function, activity, or step) encompasses means X adapted, configured, or arranged specifically, but not necessarily exclusively, to do Y.

Features, elements, components, integers, steps, processes, operations, functions, characteristics, properties and/or groups thereof described or disclosed in conjunction with a particular aspect, embodiment, example, or claim are to be understood to be applicable to any other aspect, embodiment, example, or claim described herein unless incompatible therewith.

The skilled person will appreciate that the techniques described herein may be used in any suitable combination.

Certain examples of the disclosure provide one or more techniques for providing neighbour cell information in an NTN. For example, certain examples of the disclosure provide one or more techniques for providing neighbour cell information in a 3GPP 5G NR NTN. However, the skilled person will appreciate that the disclosure is not limited to these examples, and may be applied in any suitable system or standard, for example one or more existing and/or future generation wireless communication systems or standards, including any existing or future releases of the same standards specification, for example 3GPP 5G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function, or purpose within the network. For example, the functionality of a NG-RAN node (e.g., a base station or gNB) in the examples below may be applied to any other suitable type of entity performing RAN functions.

A particular network entity may be implemented as a network element on a dedicated hardware, as a software instance running on a dedicated hardware, and/or as a virtualized function instantiated on an appropriate platform, e.g., on a cloud infrastructure.

The skilled person will appreciate that the disclosure is not limited to the specific examples disclosed herein. For example:

The techniques disclosed herein are not limited to 3GPP 5G.

One or more entities in the examples disclosed herein may be replaced with one or more alternative entities performing equivalent or corresponding functions, processes, or operations.

One or more of the messages in the examples disclosed herein may be replaced with one or more alternative messages, signals or other type of information carriers that communicate equivalent or corresponding information.

One or more further elements or entities may be added to the examples disclosed herein.

One or more non-essential elements or entities may be omitted in certain examples.

The functions, processes, or operations of a particular entity in one example may be divided between two or more separate entities in an alternative example.

The functions, processes, or operations of two or more separate entities in one example may be performed by a single entity in an alternative example.

Information carried by a particular message in one example may be carried by two or more separate messages in an alternative example.

Information carried by two or more separate messages in one example may be carried by a single message in an alternative example.

The order in which operations are performed and/or the order in which messages are transmitted may be modified, if possible, in alternative examples.

Certain examples of the disclosure may be provided in the form of an apparatus/device/network entity configured to perform one or more defined network functions and/or a method therefor. Certain examples of the disclosure may be provided in the form of a system (e.g., network or wireless communication system) comprising one or more such apparatuses/devices/network entities, and/or a method therefor.

### Neighbour Cell Ephemeris Signalling

In IoT NTN, 3GPP RAN2 #120 meeting the following was agreed:

### Agreements:

1. RAN2 doesn't introduce neighbour cell ephemeris in Rel-17 IoT-NTN, neither for eMTC not for NB-IOT. RAN2 agrees to support this in Rel-18, with details FFS.

In LTE IoT, as opposed to NR, the smallest maximum transport block size (TBS) is 1000 and 680 bits for a Release 13 LTE-M and NB-IOT respectively and with appropriate headers (for example MAC, radio link control (RLC), packet data convergence protocol (PDCP) and RRC headers) the RRC payload is even less. However, a single ephemeris element may require more than 120 bits, up to more than 200 bits depending on network implementation and deployment. Therefore, there may be a limitation on the number of blocks of neighbour cell ephemeris information that may be signalled.

Since IoT devices are typically less capable devices in terms of radio sensitivity, the number of receive antennas and worse processing capabilities, introducing significantly more bits in System information may worsen the network performance.

Access and mobility in an NTN relies on ephemeris and NTN configurations. For idle mode it is used to adjust the synchronization signal block (SSB)-measurement timing configuration (SMTC) and also to enable NTN-specific idle mode cell selection and reselection. In NTN, these configurations are broadcast in SIB19 (NR NTN)/SIB31 (IOT NTN).

If the UE is in idle mode and camps on an NTN and needs to measure a neighbouring cell that is a non-terrestrial cell, then it is not clear how the UE would acquire the needed information elements since SIB31 are NTN-specific.

Certain examples of the disclosure provide various techniques for providing neighbour cell ephemeris information that mitigate these problems.

The skilled person will appreciate that the various techniques disclosed herein are not only applicable to ephemeris information, but to any other suitable type of information.

The skilled person will appreciate that the various techniques disclosed herein are not only applicable to satellite payloads, but can also apply to other platforms, for example HAPS. Accordingly, references to “satellite ephemeris” may include references not only to satellites but also other NTN platforms or payloads.

The skilled person will appreciate that the various techniques disclosed herein are not only applicable to “serving” cells and “neighbouring” cells but to any other suitable types of cells, which may be referred to as “first” and “second” cells, respectively.

The skilled person will appreciate that the various techniques disclosed herein may be applied to gNB, NG-RAN cases and all related RRC signalling and/or messages, and to X2, Xn, S1, NG, F1 signalling and messages, and/or related network entities (e.g., MME, AMF, other).

The skilled person will appreciate that the various techniques disclosed herein may be applied to IoT NTN and/or NR NTN.

Various techniques for signalling neighbour cell ephemeris information will now be described.

In certain examples, the network may signal the neighbouring cell ephemeris with lower accuracy (e.g., precision, granularity, and/or coarse values, for example in terms of size/content of information elements represented in bits) as compared to serving cell ephemeris.

Signalling of neighbour cell ephemeris at lower granularity/precision may be acceptable, considering that this information may not be used to synchronize with the cell, but rather for cell measurements which would typically require lower cell information precision.

In certain examples, the precision may be configurable, for example by having multiple information elements representing the ephemeris that are then selected by the network according to the purpose. For example, the precision may depend on the NTN deployment, where in the case of satellites that move relatively slowly, there is less need to have precision related to the speed of the satellite. An example of this signalling case is disclosed in Example 1 further below.

In certain examples, the precision (e.g., lower precision) may be configured by one or more specific parameters. For example, the precision parameter(s) may signal the number of bits for each parameter, or a reduction in the number of bits used to signal the parameters compared to existing ephemeris parameters.

In certain examples, certain neighbour cell ephemeris information (e.g., not all) may be provided at reduced information precision/resolution/granularity. In this case, certain other neighbour cell ephemeris information may be provided with full precision/resolution/granularity.

In certain examples, the network may require the neighbour cell ephemeris to be provided in a certain form (e.g., single more efficient type). For example, the network may require that the neighbouring cell ephemeris is signalled using the PVT ephemeris format, which uses a relatively low number of bits, or any other suitable relatively low precision format.

In certain examples, the Common TA, which may be considered a part of ephemeris, may have its precision lowered in neighbour cell ephemeris. This may be done independently or jointly with lowering of precision of other neighbouring cell ephemeris information (e.g., signalling of the satellite position). In various examples, the precision of neighbour cell ephemeris (e.g., PVT, keplerian format, or the like) may be lowered while the precision of common TA is not lowered, or the precision of both Common TA and ephemeris may be lowered.

In certain examples, the neighbour cell ephemeris may be only partly signalled in each System Information occasion. For example, if the neighbour cell ephemeris is signalled in SIB31, the neighbour cell ephemeris may be signalled only in certain SIB31 occasions.

In certain examples, the network may provide the content (or parts) of neighbour cell information using more than one SIBs, for example in existing and/or newly defined SIBs. For example, the content of neighbour cell ephemeris may be split into different SIBs (existing and/or newly defined). The network may indicate to the UE(s) where to find the different content of neighbour cell ephemeris, i.e., in which SIBs.

In certain examples, the network may indicate which content (or parts) of neighbour cell information is provided to the UE(s), for example through system information broadcast (e.g., periodically or on-demand) and/or dedicated signalling.

In certain examples, the network may provide to the UE(s) information on the availability and/or scheduling of neighbour cell ephemeris. For example, the information may be provided through system information or dedicated signalling. For example, the information may include information on a mapping of neighbour cell ephemeris to new and/or existing SIBs. For example, the information may include information on periodicity, broadcast type (e.g., on-demand, periodical), size, resolution/precision/granularity of the neighbour cell ephemeris.

In certain examples, all of the neighbour cell ephemeris, or only a part of the neighbour cell ephemeris (e.g., a part provided/represented at lower precision or granularity), may be provided to the UE(s) via broadcast on-demand following a request from the UE(s), for example UEs in RRC_IDLE, RRC_INACTIVE, or RRC_CONNECTED. In certain examples, all or a part of the neighbour cell ephemeris may be provided to the UE(s) following an on-demand request, for example through a system information broadcast (periodically, on-demand) and/or dedicated signalling.

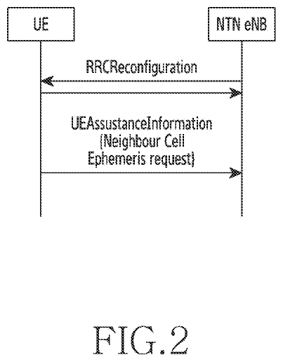

In certain examples, the neighbour cell ephemeris may be provided through dedicated signalling only, without being broadcast. This may be advantageous in some situations as neighbour cell ephemeris may not be needed if the UE is only connected for a very limited amount of time and neighbour cell ephemeris risks causing problems with broadcast coverage. In this case, the UE may signal, once it has connected, that it requires neighbour cell ephemeris. For example, the UE may signal this in response to the UE having a relatively large amount of data in a buffer. An example of this signalling is illustrated in FIG. 2.

FIG. 2 illustrates a neighbour cell request and response through dedicated signalling initiated by UE according to an embodiment of the disclosure.

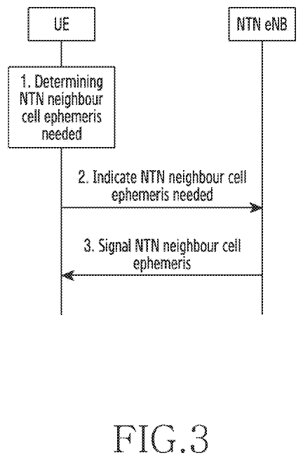

FIG. 3 illustrates a neighbour cell ephemeris request provided in a UE assistance information message according to an embodiment of the disclosure.

Referring to FIGS. 2 and 3, in operation 1, the UE may determine whether NTN neighbour cell ephemeris is needed, whether the ephemeris is required at full information precision or reduced precision, and/or whether full ephemeris or only part of the ephemeris is needed, based on any suitable set of one or more criteria, for example including one or more of the following:

The volume of data in a buffer is above a given/predefined threshold. For example, in operation 2, this may mean that the UE will remain in connected mode for long enough where the neighbour cell measurements will be required.

The serving cell signal strength is below a given/predefined threshold. For example, this may mean that mobility may be needed soon, thus the information to perform mobility may be required.

The neighbour cell(s) are being served by a different satellite. For example, in operation 2, this may indicate that the serving cell ephemeris are different to the neighbour cell ephemeris, in which case it may not be possible to derive/infer the neighbour cell ephemeris from serving cell ephemeris.

In certain examples, the indication of NTN neighbour cell ephemeris may be included in any suitable message, for example one or more of the following:

In any RRC—Complete message (sometimes referred to as Msg5):
RRCConnectionSetupComplete;
RRCConnectionResumeComplete;
RRCConnectionReconfigurationComplete; and
RRCConnectionReestablishmentComplete.

The network may indicate that the above should be provided/indicated. This may be needed if for instance there are some eNBs that have not implemented methods to send neighbour cell measurements, and some eNBs have, in which case there may be no need to send the above indication in some cases. For example, an indication that the above should be indicated may be sent in a broadcast fashion, such as SIB1 or SIB2.

In a UE assistance information message;

The RRC message is UEAssistanceInformation (see FIG. 2).

### Measurement Report

Whenever a measurement report is triggered due to RRC measurements,

the UE may indicate, for example in a flag, that neighbour cell ephemeris is needed. The RRC message is MeasurementReport

This may be configured in a reporting configuration (e.g., ReportConfigEUTRA) through a flag indicating that the need for neighbour cell ephemeris should be indicated in a Measurement report.

### In a MAC CE

In certain examples, the request and the response of neighbour cell ephemeris may be done in a new RRC message, for example neighbour cell ephemeris request/response messages, or in one or more newly defined IEs, for example NeighbourCellEphemerisRequest/NeighbourCellEphemerisResponse.

In certain examples, the UE may provide, in the request for the neighbour cell ephemeris, an indication of required/desired information, for example an indication of which part of the neighbour cell ephemeris is required, or the expected/required granularity, or the like.

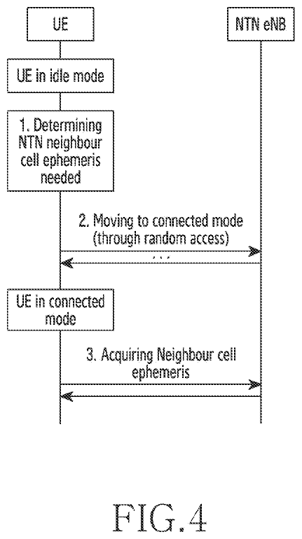

In certain examples, in operation 3, if the only method used to deliver/acquire neighbour cell ephemeris is through dedicated signalling, the UE may move from RRC idle mode to RRC connected mode to acquire neighbour cell information if the UE requires neighbour cell ephemeris for RRC idle mode operation. In certain examples, the UE may indicate the cause for connecting to the eNB, specifically to acquire NTN neighbour cell ephemeris (e.g., establishmentCause, resumeCause, re-establishmentCause). An example of this procedure is illustrated in FIG. 4.

FIG. 4 illustrates moving to radio resource control (RRC) connected mode from RRC idle mode to acquire neighbour cell ephemeris information according to an embodiment of the disclosure.

Referring to FIG. 4, in certain examples, if the neighbour cell ephemeris is broadcast, then in order to read the broadcast information, the UE may transition from RRC_CONNECTED or RRC_IDLE. This may for instance be done by the UE signalling that it wants to go to RRC_IDLE due to needing to acquire neighbour cell ephemeris in operation 1. For example, this may be done using access stratum release assistance indication (AS RAI), or by using ReleasePreference and further indicating that the AS RAI or ReleasePreference is due to the need of reading neighbour cell ephemeris.

In certain examples, if the neighbour cell ephemeris is the same as the serving cell ephemeris, the network may signal this situation, for example using a flag. This may avoid the need to signal neighbour cell ephemeris in this case. In certain examples, for each neighbouring cell, the network may only signal certain information, for example the needed PCI, the frequency, or the like. This may allow for backwards-compatible implementation. See Example 2 further below.

In certain examples, if the NTN network wants the UE to monitor a neighbouring TN cell, the network may signal that it is a TN cell. This may for instance be implicit by not including the ephemeris element, or explicit through a flag.

In certain examples, the UE may indicate its capabilities to read neighbour cell ephemeris. This can for instance be that UE is capable of reading a specific type of format that has lower resolution/precision/granularity.

### Newly Defined SIB for Neighbour Cell Ephemeris

In certain examples, the neighbour cell ephemeris may be provided in a newly defined SIB.

In this case, there may be requirements on when the new SIB is to be read, along with requirements and actions of reading the current NTN system information, such as SIB31.

In certain examples, the UE may be configured to be required to read the new neighbour cell ephemeris SIB according to one or more of the following:

Whenever the capable NTN UE reads SIB31, or just directly after having read SIB31. This may provide an advantage that the actions when reading SIB31 can be duplicated. This also requires the network to broadcast the new neighbour cell ephemeris SIB directly after the SIB31. An example of this is disclosed in Example 3 further below.

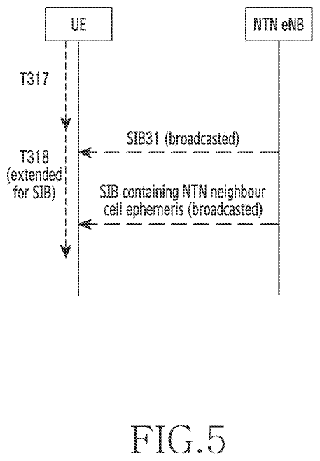

To deal with the problem of extended time for reading system information, a longer time T318 may be configured for this specific case. An example of this is illustrated in FIG. 5.

FIG. 5 illustrates reading SIB containing neighbour cell ephemeris after reading SIB31 after uplink synchronization has expired (T317) with an extended guard timer (T318) according to an embodiment of the disclosure.

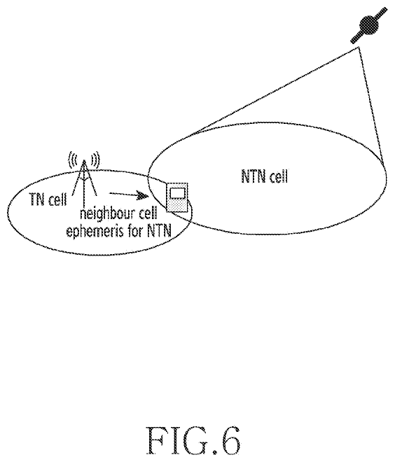

FIG. 6 illustrates providing NTN neighbour cell ephemeris over a terrestrial network (TN) cell according to an embodiment of the disclosure.

Referring to FIGS. 5 and 6, the reading of the new neighbour cell ephemeris SIB may not require its own T317 (uplink sync—ul-SyncValidityTimer) timer.

In certain examples, in operation 3 of FIG. 4, the UE may acquire the new neighbour cell ephemeris SIB whenever the SIB31 is acquired if it is detected that there have been changes to the new SIB.

In some cases, when the NTN UE reads the SIB31, such as:

When reading SIB31 when going for idle mode to connected mode.

When re-establishing connection to an NTN cell.

When certain conditions are fulfilled:
UE has more data than a certain amount in the buffer.
UE is capable of monitoring neighbouring cells in RRC connected mode.

In certain examples, the UE may be capable of monitoring neighbouring cells in RRC idle mode using NTN neighbour cell assistance information.

In certain examples, the UE may be allowed to request new SIB(s) on-demand.

### NTN Neighbour Cell Information Signalled in Terrestrial Network

In NR NTN and IoT NTN, idle and connected mode mobility is supported between a terrestrial network and a non-terrestrial network.

In certain examples, the network may signal the required non-terrestrial information in a terrestrial network. This allows the UE to measure on a non-terrestrial network while being on a terrestrial network.

In certain examples, to signal the above the network may broadcast the NTN SIB (e.g., SIB19 for NR NTN and SIB31 for IOT NTN) in a terrestrial network. To indicate that the terrestrial network is not an NTN, a flag may be included in the system information.

In certain examples, the NTN neighbour cell information may be delivered to UEs in a dedicated manner. For example, this may be done through dedicated system information delivery of SIB19 or SIB31, or in any other suitable manner, such as a separate information element with neighbour cell information, which can be sent in a separate message or as part of RRC configuration.

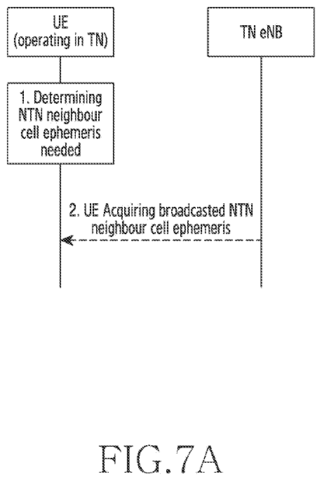

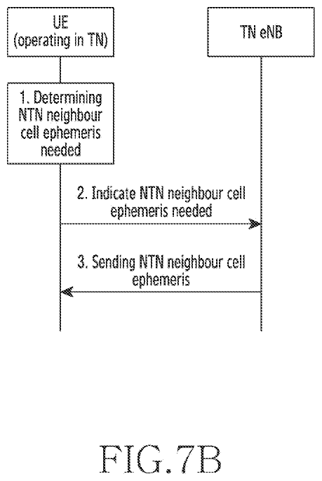

FIG. 7A illustrates acquiring broadcast NTN neighbour cell ephemeris according to an embodiment of the disclosure, and FIG. 7B illustrates indicating that NTN cell ephemeris is needed through dedicated signalling according to an embodiment of the disclosure.

Referring to FIGS. 7A and 7B, for (i) acquiring the NTN system information in a terrestrial network that is broadcast, or (ii) if provided through dedicated signalling, the UE may be configured to (a) be required to acquire the NTN system information in SIB19 or SIB31 (see FIG. 7A), or (b) indicate that the UE needs dedicated NTN neighbour cell ephemeris (see FIG. 7B). In certain examples, the conditions for any of the above may be one or more of the following:

The UE is NTN-capable.

The network indicates that it is required, for instance by configuring a flag.

The coverage of the UE is poor.

There is a radio link failure.

If the related SIB is present in a terrestrial network.

In certain examples, in operation 1, whether to acquire the NTN system information may be determined according to UE implementation and/or use, for example one or more of the following:

If the UE is expected to operate in an environment where mobility to NTN is required.

Using past history of connecting to NTN.

The serving cell ephemeris is usually present in an NTN (it is optionally present in SIB19 and mandatory present in SIB31). Certain examples of the disclosure address this problem:

The network does not signal serving cell ephemeris when the NTN SIB is signalled in a terrestrial network. This may be done for NR NTN as the serving cell ephemeris in SIB19 is optionally present.

The serving cell ephemeris is ignored. This may be done for IOT NTN as the serving cell ephemeris is mandatory present. It may for instance be ignored based on the configuration of a flag indicating to the UE that it should be ignored. In certain examples, the ephemeris signalled value may indicate this implicitly. As an example, the PVT ephemeris values may be (x=0, y=0, z=0, vx=0, vy=0, vz=0).

In this case, certain serving cell ephemeris fields may be defaulted to not be signalled, such as TA common parameters, epoch time, k-Mac, or the like.

The serving cell ephemeris may be repurposed to indicate a neighbouring NTN cell ephemeris if it is signalled in a terrestrial network.

In certain examples, in operation 2, the UE may indicate its capability to acquire NTN neighbour cell ephemeris to either a terrestrial network or a non-terrestrial network, or both.

### EXAMPLES

### Example 1

According to an embodiment of the disclosure, the embodiment regarding the Example 1 may be described like below Table 4.

TABLE 4
---------------------- Example based on 3GPP TS 36.331 V17.2.0 ----------------------

| | |
|---|---|
| - | SystemInformationBlockType31 |

The IE SystemInformationBlockType31 contains satellite assistance information for the
serving cell. SystemInformationBlockType31 is only signalled in an NTN cell.
SystemInformationBlockType31 information element
-- ASN1START
SystemInformationBlockType31-r17 ::= SEQUENCE {

| servingSatelliteInfo-r17 | ServingSatelliteInfo-r17, | |
|---|---|---|
| lateNonCriticalExtension | OCTET STRING | OPTIONAL, |

```
  ...,
  [[
```

| | |
|---|---|
| neighbourCellEphemerisList | SEQUENCE (SIZE |

```
(1..maxNeighbourCellEphemeris)) OF NeighbourCellEphemeris
  OPTIONAL,
  ]]
}
```

| | |
|---|---|
| NeighbourCellEphemeris | ::= SEQUENCE { |
| ephemerisInfo-r18 | CHOICE { |

| | |
|---|---|
| stateVectors | EphemerisStateVectors-r17, |
| stateVectorsReducedPrecision | EphemerisStateVectorsReduced-r18, |
| orbitalParameters | EphemerisOrbitalParameters-r17, |
| orbitalParametersReducedPrecision | EphemerisOrbitalParametersReduced-r17, |

```
  },
  <Other relevant info>
```

<spec text omitted>

-- ASN1STOP

... spec text omitted ...

| | |
|---|---|
| - | EphemerisOrbitalParameters |

The IE EphemerisOrbitalParameters provides satellite ephemeris in format of orbital
parameters in ECI.
EphemerisOrbitalParameters information element
-- ASN1START
EphemerisOrbitalParameters-r17 ::= SEQUENCE {

| | |
|---|---|
| semiMajorAxis-r17 | INTEGER (0..8589934591), |

| | |
|---|---|
| eccentricity-r17 | INTEGER (0..1048575), |

| | |
|---|---|
| periapsis-r17 | INTEGER (0..268435455), |
| longitude-r17 | INTEGER (0..268435455), |
| inclination-r17 | INTEGER (−67108864..67108863), |

| | |
|---|---|
| anomaly-r17 | INTEGER (0..268435455) |

}
EphemerisOrbitalParametersReduced-r18 ::= SEQUENCE {

| | |
|---|---|
| semiMajorAxis-r17 | INTEGER (0..4294976294), |

| | |
|---|---|
| eccentricity-r17 | INTEGER (0..524286), |

| | |
|---|---|
| periapsis-r17 | INTEGER (0..134217726), |
| longitude-r17 | INTEGER (0..134217726), |
| inclination-r17 | INTEGER (−33554432..33554432), |

| | |
|---|---|
| anomaly-r17 | INTEGER (0..134217726) |

}
-- ASN1STOP
EphemerisOrbitalParameters field descriptions
anomaly
Mean anomaly M at epoch time, see NIMA TR 8350.2 [110]. Unit in radian.
Step of 2.341* 10⁻⁸ rad in EphemerisOrbitalParameters-r17 and Step of 2 × 2.341* 10⁻⁸
rad in EphemerisOrbitalParametersReduced-r18. Actual value = field value * (2.341*
10⁻⁸).
eccentricity
Eccentricity e, see NIMA TR 8350.2 [110].
Step 1.431 * 10⁻⁸ in EphemerisOrbitalParameters-r17 and Step of 2 × 1.431 * 10⁻⁸ in
EphemerisOrbitalParametersReduced-r18. Actual value = field value * (1.431 * 10⁻⁸).
inclination
Inclination i, see NIMA TR 8350.2 [110]. Unit in radian.
Step of 2.341* 10⁻⁸ rad in EphemerisOrbitalParameters-r17 and Step of 2 × 2.341* 10⁻⁸
rad in EphemerisOrbitalParametersReduced-r18. Actual value = field value * (2.341*
10⁻⁸).
longitude
Longitude of ascending node Ω, see NIMA TR 8350.2 [110]. Unit in radian.
Step of 2.341* 10⁻⁸ rad in EphemerisOrbitalParameters-r17 and Step of 2 × 2.341* 10⁻⁸
rad in EphemerisOrbitalParametersReduced-r18. Actual value = field value * (2.341*
10⁻⁸).
periapsis
Argument of periapsis ω, see NIMA TR 8350.2 [110]. Unit in radian.
Step of 2.341* 10⁻⁸ rad in EphemerisOrbitalParameters-r17 and Step of 2 × 2.341* 10⁻⁸
rad in EphemerisOrbitalParametersReduced-r18. Actual value = field value * (2.341*
10⁻⁸).
semiMajorAxis
Semi major axis α, see NIMA TR 8350.2 [110]. Unit in meter.
Step of 4.249 * 10⁻³ m in EphemerisOrbitalParameters-r17 and step of 2 × 4.249 * 10⁻³ m
in EphemerisOrbitalParametersReduced-r18. Actual value = 6500000 + field value *
(4.249 * 10⁻³).

| | |
|---|---|
| - | EphemerisStateVectors |

The IE EphemerisStateVectors provides satellite ephemeris in format of position and
velocity state vectors in ECEF.
EphemerisStateVectors information element
-- ASN1START
EphemerisStateVectors-r17 ::= SEQUENCE {

| | |
|---|---|
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}
PositionStateVectorReduced-r17 ::= INTEGER (−33554432..33554431)
VelocityStateVectorReduced-r17 ::= INTEGER (−131072..131071)

| | |
|---|---|
| EphemerisStateVectorsReduced-r18 ::= | SEQUENCE { |

| | |
|---|---|
| positionX-r18 | PositionStateVectorReduced-r18, |
| positionY-r18 | PositionStateVectorReduced-r18, |
| positionZ-r18 | PositionStateVectorReduced-r18, |
| velocityVX-r18 | VelocityStateVectorReduced-r18, |
| velocityVY-r18 | VelocityStateVectorReduced-r18, |
| velocityVZ-r18 | VelocityStateVectorReduced-r18 |

}
PositionStateVectorReduced-r18 ::= INTEGER (−33554432..33554431)
VelocityStateVectorReduced-r18 ::= INTEGER (−131072..131071)
-- ASN1STOP
EphemerisStateVectors field descriptions
positionX, position Y, positionZ
X, Y, Z coordinate of satellite position state vector in ECEF. Unit in meter.
Step of 1.3 m for EphemerisState Vectors-r17 and step of 2.6 m for
EphemerisState VectorsReduced-r18. Actual value = field value * 1.3 or field value * 2.6.
velocity VX, velocity VY, velocity VZ
X, Y, Z coordinate of satellite velocity state vector in ECEF. Unit in meter/second.
Step of 0.06 m/s for EphemerisState Vectors-r17 and step of 0.12 m/s for
EphemerisStateVectorsReduced-r18. Actual value = field value * 0.06 or field value 0.12
m/s.
---------------------- Example based on 3GPP TS 36.331 V17.2.0 ----------------------

### Example 2

In this example, the network signals that the neighbouring cell ephemeris is the same as the serving cell ephemeris.

According to an embodiment of the disclosure, the embodiment regarding the Example 2 may be described like below Table 5.

TABLE 5

| | |
|---|---|
| - | SystemInformationBlockType31 |

The IE SystemInformationBlockType31 contains satellite assistance information for the
serving cell. SystemInformationBlockType31 is only signalled in an NTN cell.
SystemInformationBlockType31 information element
-- ASN1START
SystemInformationBlockType31-r17 ::= SEQUENCE {

| servingSatelliteInfo-r17 | ServingSatelliteInfo-r17, | |
|---|---|---|
| lateNonCriticalExtension | OCTET STRING | OPTIONAL, |

```
  ... ,
  [[
```

| | |
|---|---|
| neighbourCellEphemerisList | SEQUENCE (SIZE |

```
(1..maxNeighbourCellEphemeris)) OF NeighbourCellEphemeris
  OPTIONAL,
  ]]
}
```

| ServingSatelliteInfo-r17 ::= | | SEQUENCE { |
|---|---|---|
| ephemerisInfo-r17 | | CHOICE { |
| | stateVectors | EphemerisStateVectors-r17, |
| | orbitalParameters | EphemerisOrbitalParameters-r17 |

},

| nta-CommonParameters-17 | | SEQUENCE { | |
|---|---|---|---|
| | nta-Common-r17 | INTEGER (0..8316827) | OPTIONAL, |

-- Need OP

| | | |
|---|---|---|
| nta-CommonDrift-r17 | INTEGER (−261935..261935) | OPTIONAL, |

-- Need OP

| | | |
|---|---|---|
| nta-CommonDriftVariation-r17 | INTEGER (0..29479) | OPTIONAL -- |

Need OP
},

| | |
|---|---|
| ul-SyncValidityDuration-r17 | ENUMERATED {s5, s10, s15, s20, s25, s30, s35, |

s40,

s45, s50, s55, s60, s120, s180, s240, s900},

| | |
|---|---|
| epochTime-r17 | SEQUENCE { |

| | |
|---|---|
| startSFN-r17 | INTEGER (0..1023), |
| startSubFrame-r17 | INTEGER (0..9) |

| | |
|---|---|
| } | OPTIONAL, -- Need |

OP

| k-Offset-r17 | INTEGER (0..1023), | |
|---|---|---|
| k-Mac-r17 | INTEGER (1..512) | OPTIONAL, -- Need |

OP
...
}

| | |
|---|---|
| NeighbourCellEphemeris | ::= SEQUENCE { |
| ephemerisInfo-r18 | CHOICE { |

| | |
|---|---|
| stateVectors | EphemerisStateVectors-r17, |
| orbitalParameters | EphemerisOrbitalParameters-r17, |
| sameAsServingCell | ENUMERATED {true} |

```
  },
  <Other relevant info>
}
-- ASN1STOP
SystemInformationBlockType31 field descriptions
epochTime
Epoch time of the satellite ephemeris data and common TA parameters, see TS 36.213
[23]. The reference point for epoch time of the serving satellite ephemeris and Common
TA parameters is the uplink time synchronization reference point.
epochTime is the starting time of a DL subframe indicated by startSFN and
startSubframe.
If the field is absent, the UE uses the starting time of the DL subframe corresponding to
the end of the SI window during which the SI message carrying SIB31 is transmitted.
E-UTRAN always includes epochTime when SystemInformationBlockType31 is provided
through dedicated signalling.
k-Mac
Scheduling offset used when downlink and uplink frame timing are not aligned at the
eNB, see TS 36.213 [23]. Unit in ms.
If the field if absent, the UE uses the (default) value of 0.
k-Offset
Scheduling offset used in the timing relationships in NTN, see TS 36.213 [23]. Unit in
ms.
nta-Common
Network-controlled common TA, see TS 36.213 [23]. Unit of μs.
Step of 32.55208 × 10⁻³ μs. Actual value = field value * 32.55208 × 10⁻³.
If the field is absent, the UE uses the (default) value of 0.
nta-CommonDrift
Drift rate of the common TA, see TS 36.213 [23]. Unit of μs/s.
Step of 0.2 × 10⁻³ μs/s. Actual value = field value * 0.2 × 10⁻³.
If the field is absent, the UE uses the (default) value of 0.
nta-CommonDriftVariation
Drift rate variation of the common TA, see TS 36.213 [23]. Unit of μs/s².
Step of 0.2 × 10⁻⁴ μs/s². Actual value = field value * 0.2 × 10⁻⁴.
If the field is absent, the UE uses the (default) value of 0.
orbitalParameters
Instantaneous values of the satellite orbital parameters. The signalled values are only
valid for the duration as defined by ul-SyncValidationDuration and epochTime.
sameAsServingCell
Indicates that the neighbour cell ephemeris is the same as the serving cell ephemeris.
state Vectors
Instantaneous values of the satellite state vectors. The signalled values are only valid for
the duration as defined by ul-SyncValidationDuration and epochTime.
ul-Sync ValidationDuration
Validity duration of the satellite ephemeris data and common TA parameters, i.e.,
maximum time during which the UE can apply the satellite ephemeris without acquiring
new satellite ephemeris, see TS 36.213 [23]. Unit in second.
Value s5 corresponds to 5 seconds, value s10 corresponds to 10 seconds and so on.
```

### Example 3

In this case, in operation 2, the UE acquires the neighbour cell ephemeris in RRC idle mode if it is capable of performing NTN neighbour cell measurements using the NTN ephemeris and if it is capable of performing NTN neighbour cell measurements in RRC connected mode using the NTN neighbour cell ephemeris. The UE also reads the new SIB directly after SIB31. In operation 3, the TN eNB sends NTN neighbour cell ephemeris to the UE.

According to an embodiment of the disclosure, the embodiment regarding the Example 3 may be described like below Table 6.

TABLE 6
---------------------- Example based on 3GPP TS 36.331 V17.2.0 ----------------------
5.2.2.3 System information required by the UE
The UE shall:

| 1> | ensure having a valid version, as defined below, of (at least) the following system | |
|---|---|---|
| | information, also referred to as the ‘required’ system information: | |
| | 2> | if in RRC_IDLE: |

| 3> | if the UE is a NB-IoT UE: | |
|---|---|---|
| | 4> | the MasterInformationBlock-NB/ MasterInformationBlock-TDD-NB and |
| | | SystemInformationBlockType1-NB as well as |
| | | SystemInformationBlockType2-NB through SystemInformationBlockType5- |
| | | NB, SystemInformationBlockType22-NB; |
| 3> | else: | |
| | 4> | the MasterInformationBlock and SystemInformationBlockType1 (or |
| | | SystemInformationBlockType1-BR depending on whether the UE is a BL UE |
| | | or the UE in CE) as well as SystemInformationBlockType2 through |
| | | SystemInformationBlockType8 and SystemInformationBlockType24 |
| | | (depending on support of the concerned RATs), |
| | | SystemInformationBlockType17 (depending on support of RAN-assisted |
| | | WLAN interworking when the UE is connected to EPC), |
| | | SystemInformationBlockType25 (depending on support of E-UTRA/5GC), |
| | | SystemInformationBlockType29 (only for BL UE or the UE in CE |
| | | depending on support of resource reservation), |
| | | SystemInformationBlockType21, SystemInformationBlockType26 (if UE is |
| | | capable of V2X sidelink communication and is configured by upper layers |
| | | to receive or transmit V2X sidelink communication), and |
| | | SystemInformationBlockType28 (if UE is capable of NR sidelink |
| | | communication and is configured by upper layers to receive or transmit NR |
| | | sidelink communication), SystemInformationBlockType 30 (if UE is |
| | | configured by upper layers to report disaster roaming related information), |
| | | and SystemInformationBlockTypeXX (if UE is capable of performing |
| | | measurements using NTN neighbour cell assistance information). |

| | |
|---|---|
| 3> | if initiating a RRC connection establishment/resume procedure; and |
| 3> | the UE is NTN capable: |

| | |
|---|---|
| 4> | SystemInformationBlockType31 (SystemInformationBlockType31-NB in NB- |
| | IoT), if scheduled; |
| 4> | SystemInformationBlockTypeXX (if UE is supports performing |
| | measurements using NTN neighbour cell assistance information in RRC |
| | connected mode) |
| | ... spec text omitted ... |

5.2.2.4 System information acquisition by the UE
The UE shall:

... spec text omitted ...

| 1> | if the UE is NTN capable: | |
|---|---|---|
| | 2> | if schedulingInfoList indicates that SystemInformationBlockType31 |
| | | (SystemInformationBlockType31-NB in NB-IoT) is present: |

| | |
|---|---|
| 3> | immediately before establishing, resuming or re-establishing an RRC |
| | connection; or |
| 3> | if in RRC_CONNECTED and T317 is not running: |
| 4> | acquire SystemInformationBlockType31 (SystemInformationBlockType31- |
| | NB in NB-IoT); |
| 4> | acquire SystemInformationBlockTypeXX is scheduled and UE is capable of |
| | acquiring NTN neighbour cell information; |

| | |
|---|---|
| 2> | if the UE supports discontinuous coverage; and |
| 2> | if schedulingInfoList indicates that SystemInformationBlockType32 |
| | (SystemInformationBlockType32-NB in NB-IoT) is present and the UE does not |
| | have a valid version of this system information block: |

| | |
|---|---|
| 3> | acquire SystemInformationBlockType32 (SystemInformationBlockType32-NB |
| | in NB-IoT); |

| | |
|---|---|
| | ... spec text omitted ... |
| 5.3.18 | T317 expiry |

The UE shall:

| 1> | if in RRC_CONNECTED: | |
|---|---|---|
| | 2> | inform lower layers that the UL synchronisation is lost; |
| | 2> | start timer T318; |
| | 2> | acquire SystemInformationBlockType31 (SystemInformationBlockType31-NB in |
| | | NB-IoT) as specified in 5.2.2; and, |
| | 2> | acquire SystemInformationBlockTypeXX (if UE is supports performing |
| | | measurements using NTN neighbour cell assistance information in RRC |
| | | connected mode) |
| | 2> | upon successful acquisition of SystemInformationBlockType31 |
| | | (SystemInformationBlockType31-NB in NB-IoT); and |
| | 2> | upon successful acquisition of SystemInformationBlockTypeXX |
| | | (SystemInformationBlockTypeXX-NB in NB-IoT) if UE supports performing |
| | | measurements using NTN neighbour cell assistance information in RRC |
| | | connected mode; |

| | |
|---|---|
| 3> | stop timer T318; |
| 3> | inform lower layers that the UL synchronisation is restored; |

| | |
|---|---|
| NOTE: | SystemInformationBlockType31 (SystemInformationBlockType31-NB in NB- |
| | IoT) may be broadcast on a different narrowband or different NB-IoT carrier |
| | than the one configured to the UE. |

---------------------- Example based on 3GPP TS 36.331 V17.2.0 ----------------------

### Example 4

In this example, the T318 timer is extended for the UEs that are attempting to acquire the new SIB containing neighbour cell ephemeris.

According to an embodiment of the disclosure, the embodiment regarding the Example 4 may be described like below Table 7.

TABLE 7
---------------------- Example based on 3GPP TS 36.331 V17.2.0 ----------------------

| | |
|---|---|
| - | RadioResourceConfigCommon |

The IE RadioResourceConfigCommonSIB and IE RadioResource ConfigCommon are used
to specify common radio resource configurations in the system information and in the
mobility control information, respectively, e.g., the random access parameters and the
static physical layer parameters.
RadioResourceConfigCommon information element
-- ASN1START
RadioResourceConfigCommonSIB ::= SEQUENCE {

| | |
|---|---|
| rach-ConfigCommon | RACH-ConfigCommon, |
| bcch-Config | BCCH-Config, |
| pcch-Config | PCCH-Config, |
| prach-Config | PRACH-ConfigSIB, |
| pdsch-ConfigCommon | PDSCH-ConfigCommon, |
| pusch-ConfigCommon | PUSCH-ConfigCommon, |
| pucch-ConfigCommon | PUCCH-ConfigCommon, |

| | |
|---|---|
| soundingRS-UL-ConfigCommon | SoundingRS-UL-ConfigCommon, |

| | |
|---|---|
| uplinkPowerControlCommon | UplinkPowerControlCommon, |
| ul-CyclicPrefixLength | UL-CyclicPrefixLength, |

...,

| | | |
|---|---|---|
| [[ | uplinkPowerControlCommon-v1020 | UplinkPowerControlCommon-v1020 |

```
  OPTIONAL -- Need OR
  ]],
```

| | | |
|---|---|---|
| [[ | rach-ConfigCommon-v1250 | RACH-ConfigCommon-v1250 |

```
  OPTIONAL -- Need OR
  ]],
```

| | | |
|---|---|---|
| [[ | pusch-ConfigCommon-v1270 | PUSCH-ConfigCommon-v1270 |

```
  OPTIONAL -- Need OR
  ]],
```

| | | | |
|---|---|---|---|
| [[ | bcch-Config-v1310 | BCCH-Config-v1310 | OPTIONAL, |

-- Need OR

| | | |
|---|---|---|
| pcch-Config-v1310 | PCCH-Config-v1310 | OPTIONAL, |

-- Need OR

| | |
|---|---|
| freqHoppingParameters-r13 | FreqHoppingParameters-r13 |

OPTIONAL, -- Need OR

| | |
|---|---|
| pdsch-ConfigCommon-v1310 | PDSCH-ConfigCommon-v1310 |

OPTIONAL, -- Need OR

| | |
|---|---|
| pusch-ConfigCommon-v1310 | PUSCH-ConfigCommon-v1310 |

OPTIONAL, -- Need OR

| | |
|---|---|
| prach-ConfigCommon-v1310 | PRACH-ConfigSIB-v1310 |

OPTIONAL, -- Need OR

| | |
|---|---|
| pucch-ConfigCommon-v1310 | PUCCH-ConfigCommon-v1310 |

```
  OPTIONAL -- Need OR
  ]],
```

| | | |
|---|---|---|
| [[ | highSpeedConfig-r14 | HighSpeedConfig-r14 |

OPTIONAL, -- Need OR

| | |
|---|---|
| prach-Config-v1430 | PRACH-Config-v1430 |

OPTIONAL, -- Need OR

| | |
|---|---|
| pucch-ConfigCommon-v1430 | PUCCH-ConfigCommon-v1430 |

```
  OPTIONAL -- Need OR
  ]],
```

| | | |
|---|---|---|
| [[ | prach-Config-v1530 | PRACH-ConfigSIB-v1530 |

OPTIONAL, -- Cond EDT

| | | |
|---|---|---|
| ce-RSS-Config-r15 | RSS-Config-r15 | OPTIONAL, |

-- Need OR

| | | |
|---|---|---|
| wus-Config-r15 | WUS-Config-r15 | OPTIONAL, |

-- Need OR

| | |
|---|---|
| highSpeedConfig-v1530 | HighSpeedConfig-v1530 |

```
  OPTIONAL -- Need OR
  ]],
```

| | | |
|---|---|---|
| [[ | uplinkPowerControlCommon-v1540 | UplinkPowerControlCommon-v1530 |

```
  OPTIONAL -- Need OR
  ]],
```

| | | | |
|---|---|---|---|
| [[ | wus-Config-v1560 | WUS-Config-v1560 | OPTIONAL |

```
  -- Need OR
  ]],
  [[
```

| | | |
|---|---|---|
| wus-Config-v1610 | WUS-Config-v1610 | OPTIONAL, |

-- Need OR

| | | |
|---|---|---|
| highSpeedConfig-v1610 | HighSpeedConfig-v1610 | OPTIONAL, |

-- Need OR

crs-ChEstMPDCCH-ConfigCommon-r16 CRS-ChEstMPDCCH-

ConfigCommon-r16 OPTIONAL, -- Need OR

| | |
|---|---|
| gwus-Config-r16 | GWUS-Config-r16 |

OPTIONAL, -- Need OR

| | |
|---|---|
| uplinkPowerControlCommon-v1610 | UplinkPowerControlCommon-v1610 |

OPTIONAL, -- Need OR

| | |
|---|---|
| rss-MeasConfig-r16 | ENUMERATED {enabled} |

OPTIONAL, -- Need OR

| | |
|---|---|
| rss-MeasNonNCL-r16 | ENUMERATED {enabled} |

OPTIONAL, -- Need OR

| | |
|---|---|
| puncturedSubcarriersDL-r16 | BIT STRING (SIZE (2)) |

OPTIONAL, -- Need OR

| | |
|---|---|
| highSpeedInterRAT-NR-r16 | BOOLEAN |

```
  OPTIONAL -- Need OR
  ]],
  [[
```

| | | |
|---|---|---|
| pcch-Config-v1700 | PCCH-Config-v1700 | OPTIONAL, |

-- Need OR

| | |
|---|---|
| ntn-ConfigCommon-r17 | SEQUENCE { |

| | |
|---|---|
| ta-Report-r17 | ENUMERATED {enabled} |

OPTIONAL, -- Need OR

| | |
|---|---|
| t318-r17 | ENUMERATED { |

ms0, ms50, ms100, ms200,
ms500, ms1000, ms2000, ms4000},

| | | |
|---|---|---|
| prach-TxDuration-r17 | PRACH-TxDuration-r17 | OPTIONAL, |

-- Need OR

| | | |
|---|---|---|
| pucch-TxDuration-r17 | PUCCH-TxDuration-r17 | OPTIONAL, |

-- Need OR

| | | |
|---|---|---|
| pusch-TxDuration-r17 | PUSCH-TxDuration-r17 | OPTIONAL |

-- Need OR

| | | |
|---|---|---|
| } | OPTIONAL | -- Cond NTN |

]]
}

| | |
|---|---|
| RadioResourceConfigCommon ::= | SEQUENCE { |
| rach-ConfigCommon | RACH-ConfigCommon |

OPTIONAL, -- Need ON

| | |
|---|---|
| prach-Config | PRACH-Config, |
| pdsch-ConfigCommon | PDSCH-ConfigCommon |

OPTIONAL, -- Need ON

| pusch-ConfigCommon | PUSCH-ConfigCommon, | |
|---|---|---|
| phich-Config | PHICH-Config | OPTIONAL, -- |

Need ON

| | |
|---|---|
| pucch-ConfigCommon | PUCCH-ConfigCommon |

OPTIONAL, -- Need ON

| | |
|---|---|
| soundingRS-UL-ConfigCommon | SoundingRS-UL-ConfigCommon |

OPTIONAL, -- Need ON

| | |
|---|---|
| uplinkPowerControlCommon | UplinkPowerControlCommon |

OPTIONAL, -- Need ON

| | |
|---|---|
| antennaInfoCommon | AntennaInfoCommon |

OPTIONAL, -- Need ON

| | | |
|---|---|---|
| p-Max | P-Max | OPTIONAL, -- |

Need OP

| | | |
|---|---|---|
| tdd-Config | TDD-Config | OPTIONAL, |

-- Cond TDD

| | |
|---|---|
| ul-CyclicPrefixLength | UL-CyclicPrefixLength, |

...,

| | | |
|---|---|---|
| [[ | uplinkPowerControlCommon-v1020 | UplinkPowerControlCommon-v1020 |

```
  OPTIONAL -- Need ON
  ]],
```

| | | | |
|---|---|---|---|
| [[ | tdd-Config-v1130 | TDD-Config-v1130 | OPTIONAL -- |

Cond TDD3
]],

| | | |
|---|---|---|
| [[ | pusch-ConfigCommon-v1270 | PUSCH-ConfigCommon-v1270 |

```
  OPTIONAL -- Need OR
  ]],
  [[
```

| | |
|---|---|
| prach-Config-v1310 | PRACH-Config-v1310 |

OPTIONAL, -- Need ON

| | |
|---|---|
| freqHoppingParameters-r13 | FreqHoppingParameters-r13 |

OPTIONAL, -- Need ON

| | |
|---|---|
| pdsch-ConfigCommon-v1310 | PDSCH-ConfigCommon-v1310 |

OPTIONAL, -- Need ON

| | |
|---|---|
| pucch-ConfigCommon-v1310 | PUCCH-ConfigCommon-v1310 |

OPTIONAL, - Need ON

| | |
|---|---|
| pusch-ConfigCommon-v1310 | PUSCH-ConfigCommon-v1310 |

OPTIONAL, -- Need ON

| | |
|---|---|
| uplinkPowerControlCommon-v1310 | UplinkPowerControlCommon-v1310 |

```
  OPTIONAL -- Need ON
  ]],
```

| | | |
|---|---|---|
| [[ | highSpeedConfig-r14 | HighSpeedConfig-r14 |

OPTIONAL, -- Need OR

| | |
|---|---|
| prach-Config-v1430 | PRACH-Config-v1430 |

OPTIONAL, -- Need OR

| | |
|---|---|
| pucch-ConfigCommon-v1430 | PUCCH-ConfigCommon-v1430 |

OPTIONAL, -- Need OR

| | | |
|---|---|---|
| tdd-Config-v1430 | TDD-Config-v1430 | OPTIONAL -- |

```
Cond TDD3
  ]],
  [[
```

| | | |
|---|---|---|
| tdd-Config-v1450 | TDD-Config-v1450 | OPTIONAL -- |

Cond TDD3
]],

| | | |
|---|---|---|
| [[ | uplinkPowerControlCommon-v1530 | UplinkPowerControlCommon-v1530 |

OPTIONAL, -- Need ON

| | |
|---|---|
| highSpeedConfig-v1530 | HighSpeedConfig-v1530 |

```
  OPTIONAL -- Need OR
  ]],
  [[
```

| | | |
|---|---|---|
| highSpeedConfig-v1610 | HighSpeedConfig-v1610 | OPTIONAL, -- |

Need OR

| | |
|---|---|
| uplinkPowerControlCommon-v1610 | UplinkPowerControlCommon-v1610 |

OPTIONAL, -- Need OR

| | |
|---|---|
| highSpeedInterRAT-NR-r16 | BOOLEAN |

```
  OPTIONAL -- Need ON
  ]],
```

| | | |
|---|---|---|
| [[ | ntn-ConfigCommon-r17 | SEQUENCE { |

| | |
|---|---|
| ta-Report-r17 | ENUMERATED {enabled} |

OPTIONAL, -- Need OR

| | |
|---|---|
| t318-r17 | ENUMERATED { |

ms0, ms50, ms100, ms200, ms500,
ms1000, ms2000, ms4000, ms6000},

| | | |
|---|---|---|
| prach-TxDuration-r17 | PRACH-TxDuration-r17 | OPTIONAL, |

-- Need OR

| | | |
|---|---|---|
| pucch-TxDuration-r17 | PUCCH-TxDuration-r17 | OPTIONAL, |

-- Need OR

| | | |
|---|---|---|
| pusch-TxDuration-r17 | PUSCH-TxDuration-r17 | OPTIONAL |

-- Need OR

| | | |
|---|---|---|
| } | OPTIONAL | -- Cond NTN |

```
  ]],
  [[
```

| | |
|---|---|
| T318-extended-r18 | ENUMERATED { |

```
  ms0, ms50, ms100, ms200, ms500,
  ms1000, ms2000, ms4000, ms6000}
```

OPTIONAL, -- Need OR
]]
}

... Spec text omitted ...

-- ASN1STOP
RadioResourceConfigCommon field descriptions
... Spec text omitted ....
t318
The value of timer T318. Value ms0 corresponds with 0 ms, ms50 corresponds with 50
ms and so on.
t318-extended
The value of timer T318 if the UE is configured to acquire
SystemInformationBlockTypeXX. Value ms0 corresponds with 0 ms, ms50 corresponds
with 50 ms and so on.
... Spec text omitted ...
---------------------- Example based on 3GPP TS 36.331 V17.2.0 ----------------------

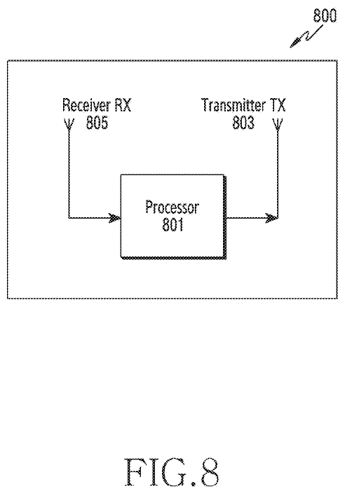

FIG. 8 is a block diagram of a network entity that may be used in examples of the disclosure according to an embodiment of the disclosure.

Referring to FIG. 8, for example, a UE and/or gNB in the examples of FIGS. 1A, 1B, 2 to 6, 7A, and 7B may comprise an entity of FIG. 8. The skilled person will appreciate that a network entity may be implemented, for example, as a network element on a dedicated hardware, as a software instance running on a dedicated hardware, and/or as a virtualized function instantiated on an appropriate platform, e.g., on a cloud infrastructure.

An entity 800 comprises a processor (or controller) 801, a transmitter 803 and a receiver 805. The receiver 805 is configured for receiving one or more messages from one or more other network entities, for example as described above. The transmitter 803 is configured for transmitting one or more messages to one or more other network entities, for example as described above. The processor 801 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the disclosure may be implemented in the form of hardware, software or any combination of hardware and software. Any such software may be stored in the form of volatile or a non-volatile storage, for example a storage device like a read-only memory (ROM), whether erasable or rewritable or not, or in the form of memory, such as, for example, a random access memory) RAM, memory chips, device or integrated circuits or on an optically or magnetically readable medium, such as, for example, a compact disc (CD), a digital versatile disc (DVD), magnetic disk or magnetic tape, or the like.

It will be appreciated that the storage devices and storage media are embodiments of machine-readable storage that are suitable for storing a program or programs comprising instructions that, when executed, implement certain examples of the disclosure. Accordingly, certain examples provide a program comprising code for implementing a method, apparatus, or system according to any example, embodiment, aspect and/or claim disclosed herein, and/or a machine-readable storage storing such a program. Still further, such programs may be conveyed electronically via any medium, for example a communication signal carried over a wired or wireless connection.

Certain examples of the disclosure provide a method, for a user equipment (UE), for acquiring second cell information (e.g., ephemeris information) of a second cell (e.g., a neighbouring cell), wherein the second cell is a non terrestrial network (NTN) cell, the method comprising: in response to expiry of a first timer (e.g., T317), indicating that validity of first cell information (e.g., ephemeris information) of a first cell (e.g., a serving cell) has expired, starting a second timer (e.g., T318), and attempting to acquire the second cell information during the second timer period.

In certain examples, in the case that acquisition of the second cell information is attempted during the second timer period, a longer time may be configured for the second timer compared to a case that acquisition of the second cell information is not attempted during the second timer period.

In certain examples, the method may further comprise: attempting to acquire the first cell information during the second timer period.

In certain examples, acquisition of the second cell information may be attempted (i) at the same time as acquisition of the first cell information is attempted, or (ii) after the first cell information has been acquired.

In certain examples, the second cell information may be included in system information (e.g., a system information block (SIBxx)) different from system information (e.g., SIB31) including the first cell information.

In certain examples, the method may further comprise: broadcasting, by a network, the second cell information (e.g., SIBxx) directly after the first cell information (e.g., SIB31).

In certain examples, the UE may be in connected mode (e.g., radio resource control (RRC) connected mode).

In certain examples, the method may further comprise: determining one or more of: whether the UE is capable of acquiring the second cell information, and whether the UE is NTN capable.

In certain examples, the first cell may be an NTN cell or a terrestrial network (TN) cell.

Certain examples of the disclosure provide a base station configured to perform a method according to any example, aspect, embodiment and/or claim disclosed herein.

Certain examples of the disclosure provide a network (or wireless communication system) comprising a base station and a UE according to any examples, aspects, embodiments and/or claims disclosed herein.

Certain examples of the disclosure provide a computer program comprising instructions which, when the program is executed by a computer or processor, cause the computer or processor to carry out a method according to any example, aspect, embodiment and/or claim disclosed herein.

Certain examples of the disclosure provide a computer or processor-readable data carrier having stored thereon a computer program according to any example, aspect, embodiment and/or claim disclosed herein.

Certain examples of the disclosure provide one or more methods, base stations, networks, computer programs and/or computer or processor-readable data carriers according to one or more of the following aspects.

In accordance with a first aspect, there is provided a method, for a first cell (e.g., a serving cell), for providing cell information (e.g., ephemeris information) of a second cell (e.g., a neighbouring cell), wherein the second cell is a non terrestrial network (NTN) cell, the method comprising transmitting, to a UE in the first cell, the cell information of the second cell, wherein the cell information of the second cell is transmitted: (i) using fewer bits, (ii) less frequently, and/or (iii) in more parts, than transmission, to the UE, of cell information of the first cell.

In accordance with a second aspect, there is provided a method according to the first aspect, wherein transmitting the cell information of the second cell using fewer bits comprises transmitting at least a first portion of the cell information of the second cell (e.g., common TA) using fewer bits than a corresponding portion of the cell information of the first cell.

In accordance with a third aspect, there is provided a method according to the second aspect, wherein transmitting the cell information of the second cell using fewer bits comprises transmitting a second portion of the cell information of the second cell using the same number or more bits than a corresponding portion of the cell information of the first cell.

In accordance with a fourth aspect, there is provided a method according to the first, second or third aspect, wherein transmitting the cell information of the second cell using fewer bits comprises transmitting at least a portion of the cell information of the second cell with lower accuracy (e.g., lower precision, lower granularity, higher coarseness) than the cell information of the first cell.

In accordance with a fifth aspect, there is provided a method according to any preceding aspect, wherein transmitting the cell information of the second cell using fewer bits comprises transmitting only a portion of the cell information of the second cell.

In accordance with a sixth aspect, there is provided a method according to any preceding aspect, wherein transmitting the cell information of the second cell using fewer bits comprises transmitting at least a portion of the cell information of the second cell using a format (e.g., PVT format) and/or encoding different from the format and/or encoding used to transmit the cell information of the first cell.

In accordance with a seventh aspect, there is provided a method according to any preceding aspect, wherein respective portions of the cell information of the second cell are transmitted in respective information elements (IEs).

In accordance with an eighth aspect, there is provided a method according to any preceding aspect, wherein the cell information of the second cell is transmitted based on a network configuration (e.g., defining the total number of bits used to transmit the information and/or the number of bits used to define each parameter of the information).

In accordance with a ninth aspect, there is provided a method according to any preceding aspect, wherein transmitting the cell information of the second cell less frequently comprises: transmitting at least a portion of the cell information of the second cell in only some scheduled transmissions (e.g., SIB transmissions/SIB occasions).

In accordance with a tenth aspect, there is provided a method according to any preceding aspect, wherein transmitting the cell information of the second cell using more parts comprises transmitting a first portion of the cell information of the second cell in a first system information block (SIB) (e.g., SIB 31), and transmitting a second portion of the cell information of the second cell in a second SIB (e.g., SIB other than SIB31).

In accordance with an eleventh aspect, there is provided a method according to the tenth aspect, wherein the method further comprises obtaining (e.g., through system information, broadcast, dedicated signalling and/or in response to a request), by the UE, information defining one or more of: the identity of the SIBs including the first and second portions of the cell information of the second cell, the availability of the first and second SIBs, and the scheduling of the first and second SIBs.

In accordance with a twelfth aspect, there is provided a method according to any preceding aspect, wherein the cell information of the second cell is transmitted according to one or more of periodically, in response to a request (e.g., from the UE), through system information, through a broadcast transmission, through dedicated signalling.

In accordance with a thirteenth aspect, there is provided a method according to any preceding aspect, further comprising receiving, from the UE, an indication of a cell (e.g., the second cell), and in response to the indication, transmitting cell information of the indicated cell.

In accordance with a fourteenth aspect, there is provided a method according to the thirteenth aspect, further comprising determining, by the UE, based on one or more certain criteria, a cell for which cell information is required.

In accordance with a fifteenth aspect, there is provided a method according to the fourteenth aspect, wherein the one or more criteria are based on one or more of: an amount of data in a buffer of the UE (e.g., whether an amount of data in the buffer exceeds a certain threshold), first cell signal strength (e.g., whether the signal strength of the first cell measured by the UE is below a certain threshold), which satellite serves the second cell (e.g., whether the second cell is served by a different satellite to the first cell).

In accordance with a sixteenth aspect, there is provided a method according to any preceding aspect, wherein the first cell is an NTN cell or a terrestrial network (TN) cell.

In accordance with a seventeenth aspect, there is provided a base station configured to perform a method according to any preceding aspect.

In accordance with an eighteenth aspect, there is provided a network (or wireless communication system) comprising a base station according to the seventeenth aspect, and a UE.

In accordance with a nineteenth aspect, there is provided a computer program comprising instructions which, when the program is executed by a computer or processor, cause the computer or processor to carry out a method according to any of the first to sixteenth aspects.

In accordance with a twentieth aspect, there is provided a computer or processor-readable data carrier having stored thereon a computer program according to the nineteenth aspect.

According to an embodiment of the disclosure, a method, for a user equipment (UE), for acquiring second cell information (e.g., ephemeris information) of a second cell (e.g., a neighbouring cell), wherein the second cell is a non terrestrial network (NTN) cell, the method comprising in response to expiry of a first timer (e.g., T317), indicating that validity of first cell information (e.g., ephemeris information) of a first cell (e.g., a serving cell) has expired, starting a second timer (e.g., T318), and attempting to acquire the second cell information during the second timer period.

According to an embodiment of the disclosure, in the case that acquisition of the second cell information is attempted during the second timer period, a longer time is configured for the second timer compared to a case that acquisition of the second cell information is not attempted during the second timer period.

According to an embodiment of the disclosure, further comprising: attempting to acquire the first cell information during the second timer period.

According to an embodiment of the disclosure, acquisition of the second cell information is attempted (i) at the same time as acquisition of the first cell information is attempted, or (ii) after the first cell information has been acquired.

According to an embodiment of the disclosure, the second cell information is included in system information (e.g., a system information block (SIBxx)) different from system information (e.g., SIB31) including the first cell information.

According to an embodiment of the disclosure, further comprising: broadcasting, by a network, the second cell information (e.g., SIBxx) directly after the first cell information (e.g., SIB31).

According to an embodiment of the disclosure, the UE is in connected mode (e.g., radio resource control (RRC) connected mode).

According to an embodiment of the disclosure, further comprising determining one or more of whether the UE is capable of acquiring the second cell information, and whether the UE is NTN capable.

According to an embodiment of the disclosure, the first cell is an NTN cell or a terrestrial network (TN) cell.

According to an embodiment of the disclosure, a base station is configured to perform operations described above.

According to an embodiment of the disclosure, a network (or wireless communication system) comprises the base station performing operations described above, and a UE.

According to an embodiment of the disclosure, a computer program comprising instructions which, when the program is executed by a computer or processor, cause the computer or processor to carry out operations described above.

According to an embodiment of the disclosure, a computer or processor-readable data carrier having stored thereon a computer program comprising instructions which, when the program is executed by a computer or processor, cause the computer or processor to carry out operations described above.

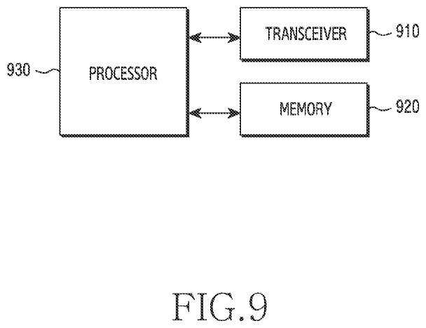

FIG. 9 illustrates a structure of a UE according to an embodiment of the disclosure.

Referring to FIG. 9, the UE according to an embodiment of the disclosure may include a transceiver 910, a memory 920, and a processor 930. The transceiver 910, the memory 920, and the processor 930 of the UE may operate according to a communication method of the UE described above. However, the components of the UE are not limited thereto. For example, the UE may include more or fewer components than those described above. In addition, the processor 930, the transceiver 910, and the memory 920 may be implemented as a single chip. In addition, the processor 930 may include at least one processor.

The transceiver 910 collectively refers to a UE receiver and a UE transmitter, and may transmit/receive a signal to/from a base station or a network entity. The signal transmitted or received to or from the base station or a network entity may include control information and data. The transceiver 910 may include a radio frequency (RF) transmitter for up-converting and amplifying a frequency of a transmitted signal, and an RF receiver for amplifying low-noise and down-converting a frequency of a received signal. However, this is only an example of the transceiver 910 and components of the transceiver 910 are not limited to the RF transmitter and the RF receiver.

In addition, the transceiver 910 may receive and output, to the processor 930, a signal through a wireless channel, and transmit a signal output from the processor 930 through the wireless channel.

The memory 920 may store a program and data required for operations of the UE. In addition, the memory 920 may store control information or data included in a signal obtained by the UE. The memory 920 may be a storage medium, such as a read-only memory (ROM), a random access memory (RAM), a hard disk, a CD-ROM, and a DVD, or a combination of storage media.

The processor 930 may control a series of processes such that the UE operates as described above. For example, the transceiver 310 may receive a data signal including a control signal transmitted by the base station or the network entity, and the processor 930 may determine a result of receiving the control signal and the data signal transmitted by the base station or the network entity.

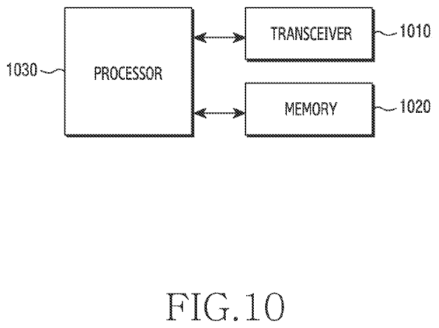

FIG. 10 illustrates a structure of a base station according to an embodiment of the disclosure.

Referring to FIG. 10, the base station according to an embodiment may include a transceiver 1010, a memory 1020, and a processor 1030. The transceiver 1010, the memory 1020, and the processor 1030 of the base station may operate according to a communication method of the base station described above. However, the components of the base station are not limited thereto. For example, the base station may include more or fewer components than those described above. In addition, the processor 1030, the transceiver 1010, and the memory 1020 may be implemented as a single chip. In addition, the processor 1030 may include at least one processor.

The transceiver 1010 collectively refers to a base station receiver and a base station transmitter, and may transmit/receive a signal to/from a terminal (UE) or a network entity. The signal transmitted or received to or from the terminal or a network entity may include control information and data. The transceiver 1010 may include an RF transmitter for up-converting and amplifying a frequency of a transmitted signal, and an RF receiver for amplifying low-noise and down-converting a frequency of a received signal. However, this is only an example of the transceiver 1010 and components of the transceiver 1010 are not limited to the RF transmitter and the RF receiver.

In addition, the transceiver 1010 may receive and output, to the processor 1030, a signal through a wireless channel, and transmit a signal output from the processor 1030 through the wireless channel.

The memory 1020 may store a program and data required for operations of the base station. In addition, the memory 1020 may store control information or data included in a signal obtained by the base station. The memory 1020 may be a storage medium, such as a read-only memory (ROM), a random access memory (RAM), a hard disk, a CD-ROM, and a DVD, or a combination of storage media.

The processor 1030 may control a series of processes such that the base station operates as described above. For example, the transceiver 1010 may receive a data signal including a control signal transmitted by the terminal, and the processor 1030 may determine a result of receiving the control signal and the data signal transmitted by the terminal.

It can also be understood that “at least one/at least one” described in this disclosure includes any and/or all possible combinations of listed items, various embodiments described in this disclosure and various examples in embodiments can be changed and combined in any suitable form, and “/” described in this disclosure means “and/or”.

The illustrative logical blocks, modules, and circuits described in this disclosure may be implemented in a general-purpose processor, a digital signal processor (DSP), an application specific integrated circuit (ASIC), field programmable gate array (FPGA) or other programmable logic devices, discrete gate or transistor logic, discrete hardware components, or any combination thereof designed to perform the functions described herein. A general-purpose processor may be a microprocessor, but in the alternative, the processor may be any processor of the related art, controller, microcontroller, or state machine. A processor may also be implemented as a combination of computing devices, such as a combination of a DSP and a microprocessor, a plurality of microprocessors, one or more microprocessors cooperating with a DSP core, or any other such configuration.

The steps of a method or algorithm described in this disclosure may be embodied directly in hardware, in a software module performed by a processor, or in a combination of the both. Software modules may reside in a RAM memory, a flash memory, a ROM memory, an erasable programmable ROM (EPROM) memory, an electrically EPROM (EEPROM) memory, registers, hard disks, removable disks, or any other form of storage media known in the art. A storage medium is coupled to a processor to enable the processor to read and write information from/to the storage medium. In the alternative, the storage medium may be integrated into the processor. The processor and storage medium may reside in an ASIC. The ASIC may reside in the user terminal. In the alternative, the processor and the storage medium may reside as separate components in the user terminal.

In one or more designs, the described functions may be implemented in hardware, software, firmware, or any combination thereof. If implemented in software, each function can be stored on or transmitted by a computer-readable medium as one or more indications or codes. Computer-readable media include both computer storage media and communication media, and the latter includes any media that facilitates the transfer of computer programs from one place to another. The storage medium can be any available medium that can be accessed by a general-purpose or special-purpose computer.

The description set forth herein, taken in conjunction with the drawings, describes example configurations, methods, and devices, and does not represent all examples that can be realized or are within the scope of the claims. As used herein, the term “example” means “serving as an example, instance or illustration” rather than “preferred” or “superior to other examples”. The detailed description includes specific details in order to provide an understanding of the described technology. However, these techniques may be practiced without these specific details. In some cases, well-known structures and devices are shown in block diagram form to avoid obscuring the concepts of the described examples.

Although this specification contains many specific implementation details, these should not be interpreted as limitations on the scope of the claimed protection, but as descriptions of specific features of specific embodiments of the disclosure. Some features described in this specification in the context of separate embodiments can also be combined in a single embodiment. On the contrary, various features described in the context of a single embodiment can also be implemented separately in multiple embodiments or in any suitable sub-combination. Furthermore, although features may be described above as functioning in certain combinations, and even initially claimed as such, in some cases, one or more features from the claimed combination may be deleted from the combination, and the claimed combination may be directed to a subcombination or a variation of a subcombination.

It should be understood that the specific order or hierarchy of steps in the method of the disclosure is illustrative of a process. Based on the design preference, it can be understood that the specific order or hierarchy of steps in the method can be rearranged to realize the functions and effects disclosed in the disclosure. The appended method claims present elements of various steps in an example order, and are not meant to be limited to the particular order or hierarchy presented, unless otherwise specifically stated. Furthermore, although elements may be described or claimed in the singular, the plural is also contemplated unless the limitation on the singular is explicitly stated. Therefore, the disclosure is not limited to the illustrated examples, and any means for performing the functions described herein are included in various aspects of the disclosure.

Text and drawings are provided as examples only to help readers understand the disclosure. They are not intended and should not be construed to limit the scope of the disclosure in any way. Although certain embodiments and examples have been provided, based on the disclosure herein, it is obvious to those skilled in the art that changes can be made to the illustrated embodiments and examples without departing from the scope of this disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a base station, a first system information block (SIB) associated with satellite assistance information, the first SIB including first information on serving cell ephemeris and second information on a validity duration of the serving cell ephemeris; and
receiving, from the base station, a second system information block (SIB) associated with neighbor satellite information based on a first timer with a duration of the validity duration of the serving cell ephemeris and a second timer for an acquisition of the first SIB before a radio link failure (RLF), the second SIB including third information on neighbor cell ephemeris.

2. The method of claim 1, wherein a validity duration of the neighbor cell ephemeris is same as the validity duration of the serving cell ephemeris.

3. The method of claim 1, wherein a validity duration of the neighbor cell ephemeris is identified based on the second timer.

4. The method of claim 1, wherein a validity duration of the neighbor cell ephemeris is explicitly signaled.

5. A user equipment (UE) in a wireless communication system, the UE comprising:
a transceiver; and
a controller coupled with the transceiver and configured to:
receive, from a base station, a first system information block (SIB) associated with satellite assistance information, the first SIB including first information on serving cell ephemeris and second information on a validity duration of the serving cell ephemeris, and
receive, from the base station, a second system information block (SIB) associated with neighbor satellite information based on a first timer with a duration of the validity duration of the serving cell ephemeris and a second timer for an acquisition of the first SIB before a radio link failure (RLF), the second SIB including third information on neighbor cell ephemeris.

6. The UE of claim 5, wherein a validity duration of the neighbor cell ephemeris is same as the validity duration of the serving cell ephemeris.

7. The UE of claim 5, wherein a validity duration of the neighbor cell ephemeris is identified based on the second timer.

8. The UE of claim 5, wherein a validity duration of the neighbor cell ephemeris is explicitly signaled.

9. A method performed by a base station in a wireless communication system, the method comprising:
transmitting, to a user equipment (UE), a first system information block (SIB) associated with satellite assistance information, the first SIB including first information on serving cell ephemeris and second information on a validity duration of the serving cell ephemeris; and
transmitting, to the UE, a second system information block (SIB) associated with neighbor satellite information based on a first timer with a duration of the validity duration of the serving cell ephemeris and a second timer for an acquisition of the first SIB before a radio link failure (RLF), the second SIB including third information on neighbor cell ephemeris.

10. The method of claim 9, wherein a validity duration of the neighbor cell ephemeris is same as the validity duration of the serving cell ephemeris.

11. The method of claim 9, wherein a validity duration of the neighbor cell ephemeris is identified based on the second timer.

12. The method of claim 9, wherein a validity duration of the neighbor cell ephemeris is explicitly signaled.

13. A base station in a wireless communication system, the base station comprising:
a transceiver; and
a controller coupled with the transceiver and configured to:
transmit, to a user equipment (UE), a first system information block (SIB) associated with satellite assistance information, the first SIB including first information on serving cell ephemeris and second information on a validity duration of the serving cell ephemeris, and
transmit, to the UE, a second system information block (SIB) associated with neighbor satellite information based on a first timer with a duration of the validity duration of the serving cell ephemeris and a second timer for an acquisition of the first SIB before a radio link failure (RLF), the second SIB including third information on neighbor cell ephemeris.

14. The base station of claim 13, wherein a validity duration of the neighbor cell ephemeris is same as the validity duration of the serving cell ephemeris.

15. The base station of claim 13, wherein a validity duration of the neighbor cell ephemeris is identified based on the second timer.

16. The base station of claim 13, wherein a validity duration of the neighbor cell ephemeris is explicitly signaled.

17. A non-transitory tangible computer-readable medium having instructions stored therein that, when executed by at least one processor of a user equipment (UE), cause the UE to perform operations, the operations comprising:
receiving, from a base station, a first system information block (SIB) associated with satellite assistance information, the first SIB including first information on serving cell ephemeris and second information on a validity duration of the serving cell ephemeris; and
receiving, from the base station, a second system information block (SIB) associated with neighbor satellite information based on a first timer with a duration of the validity duration of the serving cell ephemeris and a second timer for an acquisition of the first SIB before a radio link failure (RLF), the second SIB including third information on neighbor cell ephemeris.

18. The non-transitory tangible computer-readable medium of claim 17, wherein a validity duration of the neighbor cell ephemeris is same as the validity duration of the serving cell ephemeris.

19. The non-transitory tangible computer-readable medium of claim 17, wherein a validity duration of the neighbor cell ephemeris is identified based on the second timer.

20. The non-transitory tangible computer-readable medium of claim 17, wherein a validity duration of the neighbor cell ephemeris is explicitly signaled.
